(19) United States
(12) Patent Application Publication
(10) Pub. No.: US 2019/0012655 A1
(43) Pub. Date: Jan. 10, 2019

(54) INTEGRATED PAYMENT DEVICE

(71) Applicant: PAX COMPUTER TECHNOLOGY (SHENZHEN) CO., LTD., shenzhen, Guangdong (CN)

(72) Inventors: Deqiang Dong, Shenzhen, Guangdong (CN); Yuzhuo Wang, Shenzhen, Guangdong (CN); Liheng Deng, Shenzhen, Guangdong (CN)

(21) Appl. No.: 15/744,920

(22) PCT Filed: Jul. 31, 2017
(86) PCT No.: PCT/CN2017/095269

§ 371 Date: Jan. 15, 2018

(30) Foreign Application Priority Data
Feb. 22, 2017 (CN) 201720164156.2

(51) Int. Cl. G06Q 20/32; G07G 1/00; G06F 3/041

(52) U.S. Cl. CPC G06Q 20/3278; G06F 3/0412; G07G 1/0081; G06Q 20/3276

(57) ABSTRACT

The present application is suitable for the field of payment devices, and provides an integrated payment device including a housing. A near field payment area and a code scanning payment area are provided on the housing. A near field payment module, a code scanning payment module and a circuit board configured for controlling the near field payment module and the code scanning payment module are mounted in the housing. Both the near field payment module and the code scanning payment module are electrically connected with the circuit board. The near field payment module is located at a position corresponding to the near field payment area. The code scanning payment module is located at a position corresponding to the code scanning payment area.

### TECHNICAL FIELD

The present application pertains to the field of payment devices, and in particular, relates to an integrated payment device.

### BACKGROUND

As the technology develops, it is more and more convenient for transaction payment and there are also more payment methods, such as near field payment and code scanning payment. Currently, in order to facilitate different transaction modes of customers, merchants need to prepare different payment devices for various payment methods. For example, for near field payment, a near field payment device is required; for code scanning payment, a code scanning device is required. Many devices are used, the occupancy space is large, the cost is high, and it is inconvenient to use.

### SUMMARY

The purpose of the present application is to provide an integrated payment device, which aims at solving the problem that many payment devices are required currently in transaction payment.

The present application is realized as follows. An integrated payment device comprises a housing, wherein a near field payment area and a code scanning payment area are provided on the housing, a near field payment module, a code scanning payment module and a circuit board configured to control the near field payment module and the code scanning payment module are mounted in the housing, both the near field payment module and the code scanning payment module are electrically connected with the circuit board, the near field payment module is located at a position corresponding to the near field payment area, and the code scanning payment module is located at a position corresponding to the code scanning payment area.

Further, a display screen is further mounted on the housing, and the display screen is electrically connected with the circuit board.

Further, the display screen is a touch screen.

Further, an included angle between a front surface of the code scanning payment area and a horizontal plane is greater than an included angle between a front surface of the near field payment area and a horizontal plane.

Further, the near field payment area and the code scanning payment area are arranged longitudinally, or alternatively, the near field payment area and the scanning code payment area are juxtaposed horizontally.

Further, a connection interface configured to connect an external server is provided at the bottom of the housing, and the connection interface is electrically connected with the circuit board.

Further, the integrated payment device further comprises a base configured to support the housing and adjust an angle of the housing with respect to a horizontal direction, and the base is pivotally connected to the bottom of the housing.

Further, the base comprises a support, the support comprises a base plate and a support plate arranged obliquely to the base plate, a lower end of the support plate is connected to the base plate, and an upper end of the support plate is pivotally connected to the bottom of the housing.

Further, the support plate is connected to one end of the base plate, a clamping hole configured to clamp a conductive wire is provided in the middle of the connection between the support plate and the base plate, and the middle of the support plate is provided with an opening through which the conductive wire passes.

Further, the base further comprises a connecting block, a receiving groove configured to adaptively receive the connecting block is defined at the bottom of the housing, a convex plate is provided at the top of the support plate, a socket into which the convex plate is inserted is defined at the bottom of the connecting block, a connecting shaft which is fixed in the socket through the convex plate is mounted on the connecting block, and the connecting block is mounted in the receiving groove.

According to the present application, by providing the near field payment area and the code scanning payment area on the housing, mounting the near field payment module and the code scanning payment module in the housing, providing the near field payment module at a position corresponding to the near field payment area, and providing the code scanning payment module at the code scanning payment area, the integrated payment device may perform both near field payment and code scanning payment; in transactions, merchants only need to prepare a device, which may reduce occupancy space and reduce the cost of purchasing devices.

### BRIEF DESCRIPTION OF THE DRAWINGS

FIG. 1 is a perspective structural schematic view of an integrated payment device provided by one embodiment of the present application;

FIG. 2 is a perspective structural schematic view of the integrated payment device in FIG. 1 viewed from another perspective;

FIG. 3 is an exploded structural schematic view of the integrated payment device in FIG. 1;

FIG. 4 is an exploded structural schematic view of a bottom shell and a base in FIG. 3; and

FIG. 5 is a schematic view of an internal structure of a housing in FIG. 3.

### DESCRIPTION OF THE EMBODIMENTS

In order to make the objectives, technical solutions and advantages of the present application clearer, the present application will be further described in detail with reference to the accompanying drawings and embodiments. It should be understood that the specific embodiments described herein are only used to explain the present application, and are not intended to limit the present application.

It should be noted that when an element is referred to as being “fixed on” or “provided on” another element, the element may be directly located on the other element or there may be an intermediate element at the same time. When an element is referred to as being “connected to” another element, the element may be directly connected to the other element or there may be an intermediate element at the same time.

It should also be noted that in the description of the present application, it should be noted that the orientation or positional relationship of the terms such as “middle”, “upper”, “lower”, “horizontal”, “bottom”, “inner” and “outer” is based on the orientation or positional relationship shown in the accompanying drawings merely for the convenience of describing the present application and a simplified description rather than indicating or implying that the indicated device or element must have a particular orientation, be constructed and operate in a particular orientation. Therefore it cannot be understood as a limitation of the present application.

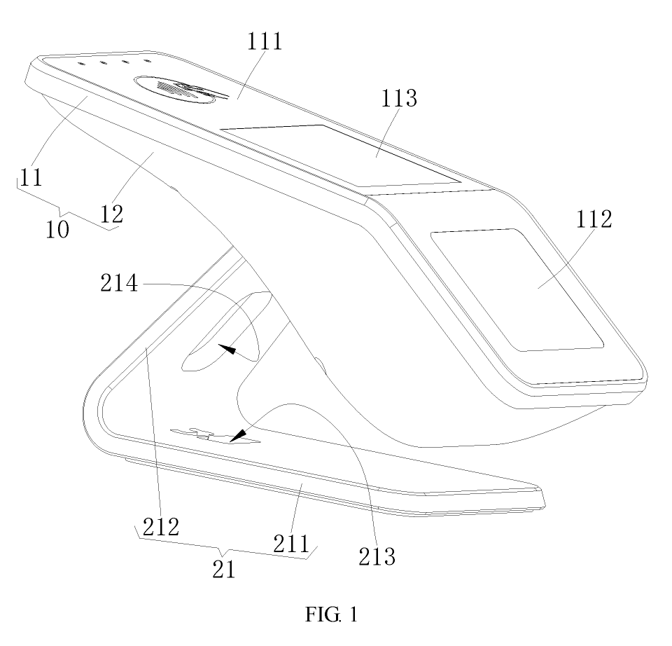

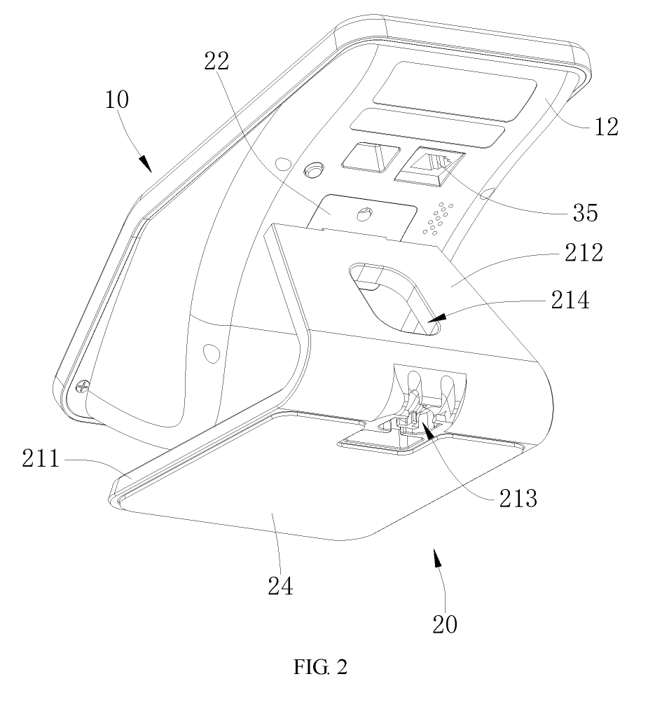

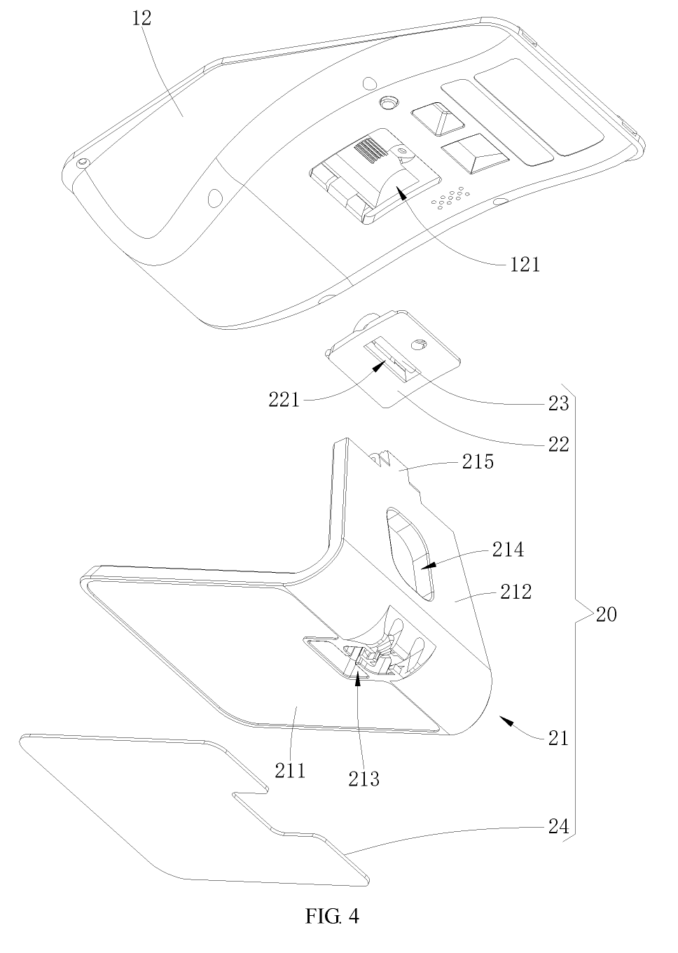

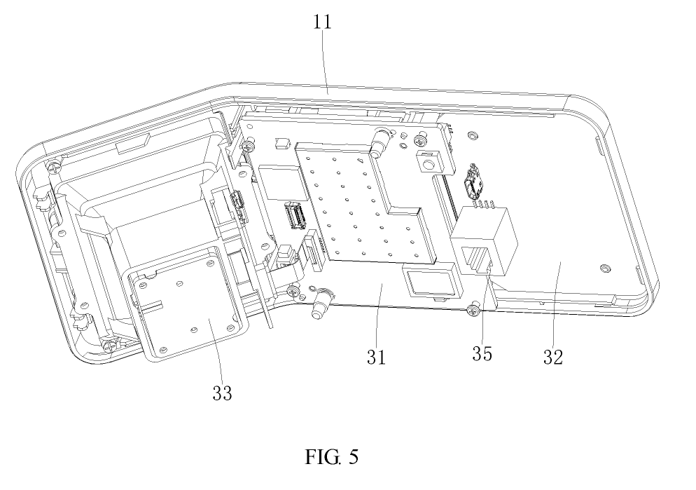

Referring to FIGS. 1-5, an integrated payment apparatus 100 according to an embodiment of the present application comprises a housing 10, a near field payment area 111 and a code scanning payment area 112 are provided on the housing 10, and a near field payment module 32, a code scanning payment module 33 and a circuit board 31 are mounted in the housing 10; the circuit board 31 is electrically connected with the near field payment module 32 and the code scanning payment module 33 to control the operation of the near field payment module 32 and the code scanning payment module 33. The near field payment module 32 is located at a position corresponding to the near field payment area 111, and the code scanning payment module 33 is located at a position corresponding to the code scanning payment area 112, so that in a process of code scanning payment, the code scanning payment may be performed only by aligning a two-dimensional code on an electronic device such as a mobile phone or a tablet with the code scanning payment area 112 on the housing 10; whereas in the process of near field payment, the near field payment may be performed only by bringing a near field payment device close to the near field payment area 111.

By providing the near field payment area 111 and the code scanning payment area 112 on the housing 10, mounting the near field payment module 32 and the code scanning payment module 33 in the housing 10, providing the near field payment module 32 at a position corresponding to the near field payment area 111, and providing the code scanning payment module 33 at the code scanning payment area 112, the integrated payment device 100 may perform both near field payment and code scanning payment; in transactions, merchants only need to prepare a device, which may reduce occupancy space and reduce the cost of purchasing devices. In addition, compared with the existing magnetic stripe card and IC card-based payment methods and payment devices, the integrated payment device 100 may better protect near field payment cards and devices, protect code scanning payment devices, prevent cards from being worn, and prevent the risk that criminals copy magnetic stripe cards.

Specifically, near field payment comprises the following categories:

Card payment: Quick Pass, VISA (Visa), MasterCard and other NFC cards (NFC cards: Near Field Communication, supporting near field wireless communication cards).

Card token payment: China Unionpay Quick Pass, Apple pay, Huawei pay, Samsung Pay, and Xiaomi Pay.

Code scanning payment comprises: WeChat code scanning payment, Alipay code scanning payment, and Unionpay code scanning payment.

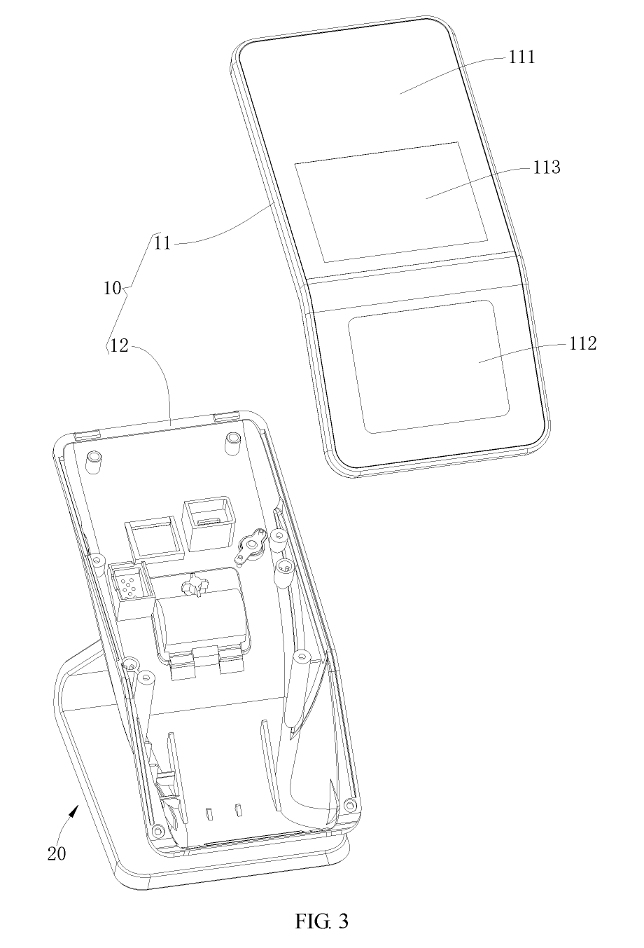

Referring to FIG. 1 and FIG. 3, further, a display screen 113 is further mounted on the housing 10, and the display screen 113 is electrically connected with the circuit board 31. The display screen 113 is provided so as to display the content of payment and thereby further facilitate customers' use.

Further, the display screen 113 is a touch screen, facilitating inputting operations through the display screen 113, and facilitating online payment at the same time. Specifically, online payment comprises: applications APPS, browsers, APP calls for various network payments (application calls for various payments), etc.

Further, the display screen 113 may also display a two-dimensional code map, so that customers can use a smart device such as a mobile phone and a tablet to perform online code scanning payment.

Further, the plane where the display screen 113 is located is in the same plane as the front surface of the near field payment area 111. This structure may facilitate the manufacture of the housing 10, and facilitate the near field payment operation while viewing the display screen 113.

Specifically, in the process of code scanning payment, there may be a cardholder scanning mode: a dynamic two-dimensional code may be displayed through the display screen 113 to facilitate scanning. Further, a two-dimensional code may be set to be updated once every one minute, so the security is better. In addition, the dynamic two-dimensional code may be acquired through networking with the background or generated by the whole machine, so as to ensure that the displayed two-dimensional code is safe. There may also be a cardholder scanned mode: the code scanning payment module 33 is used to actively scan a UnionPay two-dimensional code for payment. In the UnionPay two-dimensional code payment method, merchants may only obtain encrypted payment information, but cannot obtain other information about the bank card, which is safer. The amount of consumption is transmitted to the integrated payment device 100 by an upper computer, such as an Electronic Cash Register (ECR), and the amount is displayed on the screen. The consumer only needs to place the payment code close to the device and the device performs scanning for payment. Moreover, the device is better in performance, and is relatively low in performance requirement of a mobile phone of consumers.

Further, a Bluetooth module (not shown in the figure) is further mounted on the circuit board 31 so as to integrate the Bluetooth function and thereby be further used as a BT Beacon to attract consumers to customers; at the same time, the display screen 113 may play a video advertisement, display a two-dimensional code of the merchant, and promote advertising coupons of merchants, etc.

Further, an included angle between a front surface of the code scanning payment area 112 and a horizontal plane is greater than an included angle between a front surface of the near field payment area 111 and a horizontal plane. The included angle between a front surface of the code scanning payment area 112 and a horizontal plane is set to be larger so that the code scanning payment area 112 tends to be in the vertical position more easily. Since users usually hold the upper or lower position of a handheld card or a smart phone when performing the near field payment, they are accustomed to placing the card or the smart phone slightly obliquely to the horizontal direction; in the process of code scanning, the two sides of a smart phone or a tablet are usually held by hand so as to expose the screen, and thus the smart phone will tend to be in the vertical position. Therefore, in this embodiment, the included angle between a front surface of the code scanning payment area 112 and a horizontal plane is set to be larger, which is convenient for users to perform code scanning payment and near field payment.

Further, the range of the included angle between the front surface of the code scanning payment area 112 and a horizontal plane is 40-50 degrees. The structure enables the inclination by which users scan the code and the desktop to form an angle of 40-50 degrees so as to facilitate the scanning code operation for cardholders of different heights. The reason why different angles are designed is as follows: better facilitating the use for people of different heights and providing a better man-machine operation experience. For example, the angle of 50 degrees is more suitable for short people, and the inclination of 40 degrees is more suitable for tall people. The range of the included angle between the front surface of the code scanning payment area 112 and a horizontal plane is set to be 40-50 degrees so as to be suitable for most users.

Further, the near field payment area 111 and the code scanning payment area 112 are arranged longitudinally. Specifically, in the front-to-back longitudinal arrangement, the near field payment area 111 and the code scanning payment area 112 may be sequentially arranged. Of course, the payment code area 112 and the near field payment area 111 may be sequentially provided. In other embodiments, the near field payment area 111 and the code scanning payment area 112 are arranged side by side horizontally. Specifically, in the left-to-right horizontal arrangement, the near field payment area 111 and the code scanning payment area 112 may be sequentially arranged. Of course, the payment code area 112 and the near field payment area 111 may be sequentially arranged.

In this embodiment, since the integrated payment device 100 further comprises a display screen 113, the display screen 113, the near field payment area 111, and the code scanning payment area 112 are arranged longitudinally. For example, in this embodiment, in the front-to-back longitudinal arrangement, a code scanning payment area 112, a display screen 113 and a near field payment area 111 may be sequentially arranged. In other embodiments, in the front-to-back longitudinal arrangement, the near field payment area 111, the display screen 113 and the code scanning payment area 112 may also be sequentially arranged. There may also be sequentially: a display screen 113, a code scanning payment area 112 and a near field payment area 111; a display screen 113, a near field payment area 111, and a code scanning payment area 112; a code scanning payment area 112, a near field payment area 111 and a display screen 113; a near field payment area 111, a code scanning payment area 112 and a display screen 113. Of course, in some embodiments, the display screen 113, the near field payment area 111, and the code scanning payment area 112 may also be arranged horizontally. For example, in the left-to-right horizontal arrangement, the code scanning payment area 112, the display screen 113 and the near field payment area 111 may be sequentially arranged. In other embodiments, in the left-to-right horizontal arrangement, the near field payment area 111, the display screen 113 and the code scanning payment area 112 may also be sequentially arranged. There may also be sequentially: a display screen 113, a code scanning payment area 112 and a near field payment area 111; a display screen 113, a near field payment area 111 and a code scanning payment area 112; a code scanning payment area 112, a near field payment area 111 and a display screen 113; and a near field payment area 111, a code scanning payment area 112, and a display screen 113.

Further, a connection interface 35 configured for connecting an external server is provided at the bottom of the housing 10, and the connection interface 35 is electrically connected with the circuit board 31. A connection interface 35 is provided at the bottom of the housing 10 for facilitating the connection with an external server. For example, when the connection interface 35 is a network interface, it may be directly networked with an external server; when the connection interface 35 is a data interface, it may realize direct data connection with an external server. In still other embodiments, a wireless module such as a WiFi may be mounted in the housing 10 so as to be connected with an external server through a wireless connection.

Referring to FIGS. 3, 4 and 5, further, the integrated payment device 100 further comprises a base 20, the base 20 is pivotally connected to the bottom of the housing 10 so as to support the housing 10 through the base 20 and facilitate the adjustment of an angle between the housing 10 and a horizontal direction at the same time.

Further, the base 20 comprises a support 21, the support 21 comprises a base plate 211 and a support plate 212 provided obliquely to the base plate 211, a lower end of the support plate 212 is connected to the base plate 211, and an upper end of the support plate 212 is connected to the bottom of the housing 10. The support plate 212 is connected with the base plate 211 to form the support 21, which has the advantages of a simple structure, a convenient processing, low cost, and a light weight, and is connected with the housing 10 at the same time so as to stably support the housing 10.

Specifically, the base plate 211 and the support plate 212 may be integrally formed to ensure the connection strength between the base plate 211 and the support plate 212. In other embodiments, the support plate 212 may also be fixed on the base plate 211.

Further, the base 20 further comprises a gasket 24 fitted to the bottom surface of the base plate 211. The gasket 24 is provided to increase the friction between the base plate 211 and the media surface such as the desktop so that the base 20 may be more stably supported on the desktop. Meanwhile, the base plate 211 may be reduced in wear.

Further, the support plate 212 is connected to one end of the base plate 211, a clamping hole 213 configured for clamping a conductive wire is provided in the middle of the connection between the support plate 212 and the base plate 211, and the middle of the support plate 212 is provided with an opening 214 through which the conductive wire passes. A clamping hole 213 is defined in the support 21, and an opening 214 is defined in the middle of the support plate 212, so that the conductive wire is fixed through the clamping hole 213 so as to fix the conductive wire through which the integrated payment device 100 is connected with an external server or charged. An opening 214 is defined in the support plate 212 so that the conductive wire may be better arranged so as to ensure the cleanness of the tabletop.

Further, the base 20 further comprises a connecting block 22, a receiving groove 121 for receiving the connecting block 22 in a cooperating manner is defined at the bottom of the housing 10, a convex plate 215 is provided at the top of the support plate 212, a socket 221 into which the convex plate 215 is inserted is defined at the bottom of the connecting block 22, and a connecting shaft 23 which passes through the convex plate 215 and is fixed in the socket 221 is mounted on the connecting block 22. By using the connecting block 22 and connecting the convex plate 215 on the support plate 212 with the connecting block 22 through the connecting shaft 23, the angle between the connecting block 22 and the support plate 212 may be slightly adjusted so as to adjust the horizontal angle of the housing 10. A receiving groove 121 is provided at the bottom of the housing 10 so as to facilitate the mounting of the connecting block 22. The connecting block 22 is provided, which also facilitates the connection between the housing 10 and the support plate 212. In other embodiments, the support plate 212 may also be directly connected with the housing 10.

Further, the housing 10 comprises a top shell 11 and a bottom shell 12. The top shell 11 is fixed to the bottom shell 12 to form the housing 10. The structure facilitates processing, and also facilitates the mounting of the circuit board 31 and other parts in the housing 10 at the same time. Specifically, the receiving groove 121 is defined at the bottom surface of the bottom shell 12. The near field payment area 111 is provided on the top shell 11, the display screen 113 is provided on the top shell 11, and the code scanning payment area 112 is also provided on the top shell 11.

The above description is only the preferred embodiment of the present application, and not intended to limit the present application. Any modification, equivalent replacement and improvement made within the spirit and principle of the present application should be included within the scope of protection of the present application.

1. An integrated payment device, comprising a housing, wherein, a near field payment area and a code scanning payment area are provided on the housing, and a near field payment module, a code scanning payment module and a circuit board configured to control the near field payment module and the code scanning payment module are mounted in the housing, both the near field payment module and the code scanning payment module are electrically connected with the circuit board, the near field payment module is located at a position corresponding to the near field payment area, and the code scanning payment module is located at a position corresponding to the code scanning payment area.

2. The integrated payment device according to claim 1, wherein, a display screen is further mounted on the housing, and the display screen is electrically connected with the circuit board.

3. The integrated payment device according to claim 2, wherein, the display screen is a touch screen.

4. The integrated payment device according to any claim 1, wherein, an included angle between a front surface of the code scanning payment area and a horizontal plane is greater than an included angle between a front surface of the near field payment area and a horizontal plane.

5. The integrated payment device according to any claim 1, wherein, the near field payment area and the code scanning payment area are arranged longitudinally, or alternatively, the near field payment area and the scanning code payment area are juxtaposed horizontally.

6. The integrated payment device according to any claim 1, wherein, a connection interface configured to connect an external server is provided at the bottom of the housing, and the connection interface is electrically connected with the circuit board.

7. The integrated payment device according to any claim 1, further comprising a base configured to support the housing and adjust an angle of the housing with respect to a horizontal direction, wherein the base is pivotally connected to the bottom of the housing.

8. The integrated payment device according to claim 7, wherein the base comprises a support, the support comprises a base plate and a support plate arranged obliquely to the base plate, a lower end of the support plate is connected to the base plate, and an upper end of the support plate is pivotally connected to the bottom of the housing.

9. The integrated payment device according to claim 8, wherein the support plate is connected to one end of the base plate, a clamping hole configured to clamp a conductive wire is provided in the middle of the connection between the support plate and the base plate, and the middle of the support plate is provided with an opening through which the conductive wire passes.

10. The integrated payment device as claimed in claim 8, wherein the base further comprises a connecting block, a receiving groove configured to adaptively receive the connecting block is defined at the bottom of the housing, a convex plate is provided at the top of the support plate, a socket into which the convex plate is inserted is defined at the bottom of the connecting block, a connecting shaft which is fixed in the socket through the convex plate is mounted on the connecting block, and the connecting block is mounted in the receiving groove.
